(19) United States
(12) Patent Application Publication
(10) Pub. No.: US 2013/0159076 A1
(43) Pub. Date: Jun. 20, 2013

(54) SYSTEM AND METHOD FOR PROVIDING CONTESTS GAMES AND BENEFITS SHORTLY BEFORE, DURING AND SHORTLY AFTER A SPORTING EVENT EXCLUSIVELY FOR ATTENDEES OF THE SPORTING EVENT

(71) Applicants: Nathaniel Heisler, West Hollywood, CA (US); Richard Thurman, Malibu, CA (US); Jeffrey Scott Borris, Calabasas, CA (US)

(72) Inventors: Nathaniel Heisler, West Hollywood, CA (US); Richard Thurman, Malibu, CA (US); Jeffrey Scott Borris, Calabasas, CA (US)

(73) Assignee: SPORTS TECHNOLOGY APPLICATIONS, INC., Beverly Hills, CA (US)

(21) Appl. No.: 13/329,126

(22) Filed: Dec. 16, 2011

(51) Int. Cl. G06Q 30/00

(52) U.S. Cl. 705/14.12

(57) ABSTRACT

A method of providing a game and one or more benefits to one or more attendees of a sporting venue is provided. In one embodiment, the method comprises, (a) receiving a first piece of information from the input device of one or more attendees located at a sporting venue, (b) sending information to the input device of the one or more attendees located at the sporting venue, (c) receiving a second piece information from the input device of the one or more attendees located at the sporting venue, (d) providing one or more benefits to attendees located at the sporting venue and (e) providing one or more prizes to one or more attendees located at the sporting event.

### BACKGROUND

1. Field

The present disclosure is generally directed to providing games and contests. More specifically, the present disclosure is directed to systems and methods for providing games and contests to those specifically attending an event at an arena that provides various benefits and advantages for the user of the games and contests and those involved with the arena or hosting the event.

2. DESCRIPTION OF RELATED ART

Until now, the most common systems and methods for sporting games involve fantasy leagues and related games and programs. Although the success for fantasy type leagues is undeniable, these fantasy leagues have been limited to competition within a virtual league rather than actual event (and players in the game). Presently, no method or system allows attendees of the sporting event to compete in a game based on the live sporting event that provides various benefits and advantages. Additionally, no method or system requires that the players of the game be limited to the sporting event attendees, which creates a community among the attendees. Additionally, no method or system allows players to interact with other members of the sporting event, obtain unique content and prizes by participating in the game at the venue of the sporting event, provide a unique interactive experience exclusively for the attendees of the sporting event and provide other benefits and advantages desirable to the attendee.

In the past, systems and methods that revolve around sporting events, such as virtual fantasy sports leagues, involve people drafting real-life players of a specific sport to their virtual teams and playing those teams against other formulated teams within the same virtual league. Points would be allocated based on how well each individual player on the virtual team's roster performed during a sporting event. Winners would be determined by whose virtual teams performed the best over the course of an entire season.

Traditionally, most system and methods to date that deal with sports games are centered around virtual fantasy leagues in which players are drafted within their respective sports leagues and perform based on their real-life statistics and performances for each sporting event. Present systems and methods do not create a social network among persons in attendance of live sports games or related events at a venue, where attendees are able to compete, using wirelessly connected devices (e.g., mobile phones, tablets, kiosks, computers), amongst each other by predicting the outcome of certain in-game events or contests, related or not related to the sporting/arena event. Unlike other sports games, such as fantasy leagues, there is no season-long commitment with games played during a particular event. Attendees want the ability to play for an entire live game or only one part of the game and not have to commit to a season.

There exists a need for a system and method that connects attendees at a sporting venue together, forming a community, and providing an interactive experience to the attendee where the participant can, through an input device, make selections regarding the event, venue, or item of potential interest. For example and not by way of limitation, the attendee can make selections regarding one or more players' performance or the outcome of the sporting event. Those attendees that perform better than the other attendees receive one or more prizes or other incentives (e.g., cash, merchandise, tickets, coupons, the ability to meet players/sponsors/celebrities or other performers, and/or other prices or incentives). Further, those attendees that perform better than other attendees will be given the ability to be recognized for their superior performance by, for example, showing their image, name and/or performance to other attendees at the sporting event or receive other benefits that would be desirable to the attendees that performed better than others attendees that participated.

There is also a need for a system and method that provides sports event attendees with the opportunity to win special content and incentives only available to attendees at the sporting event venue, offers the convenience of being able to order food and other items to his or her seat, and otherwise engage with the sporting event in an interactive way that enhances the experience of the person playing the sport. This provides a better experience at the sporting event and increases the attendees' desire arrive earlier, stay longer at the sporting event and to return to future events at the sporting event venue. The methods and systems of the present disclosure provide these and other related benefits and advantages.

### SUMMARY OF THE INVENTION

In one embodiment of the present disclosure, a method of providing a game and one or more benefits to one or more attendees of a sporting venue is provided. The method comprises (a) receiving a first piece of information from the input device of one or more attendees located at a sporting venue where a sporting event is taking or is about to take place, (b) sending information to the input device of the one or more attendees located at the sporting venue, (c) receiving a second piece of information from the input device of the one or more attendees located at the sporting venue, (d) providing one or more benefits to attendees located at the sporting venue and (e) providing one or more prizes to one or more attendees located at the sporting event. In one aspect of at least one embodiment, the first piece of information received from the input device indicates or confirms that the attendee is physically located within the sporting venue and the second piece of information is the attendees selection of the outcome of the sporting event located at the venue that the attendee is at or the attendees selection of the performance of one or more players that are participating in the sporting event located at the venue that the attendee is at and where the one or more prizes are provided to attendees who most correctly selected the outcome of the sporting event or the performance of the one or more players that are participating in the sporting event located at the sporting event venue

In another aspect of at least one embodiment, the method further includes receiving a third piece information from the input device of the one or more attendees located at the sporting venue.

In yet another aspect of at least one embodiment, the input device is a mobile phone.

In yet another aspect of at least one embodiment, the first piece of information received is a validation, password, code or image.

In yet another aspect of at least one embodiment, the input device is a mobile phone.

In yet another aspect of at least one embodiment, the first piece of information received is login information.

In yet another aspect of at least one embodiment, the third piece of information received is a request to purchase something during the sporting event.

In yet another aspect of at least one embodiment, the one or more benefits provided are additional content about the sporting event or participants of the sporting event.

In yet another aspect of at least one embodiment, the first piece of information received is the location of the user.

In yet another aspect of at least one embodiment, the method further requires the one or more attendees to provide the second piece of information before the sporting event begins.

In yet another embodiment, a method of providing one or more benefits to one or more attendees of a sporting venue is provided. The method comprises (a) receiving a first piece of information from the input device of one or more attendees located at a sporting venue where a sporting event is taking or is about to take place, (b) sending information about the sporting event at the sporting venue to the input device of the one or more attendees located at the sporting venue, (c) receiving a second piece of information from the input device of the one or more attendees located at the sporting venue regarding the outcome of the sporting event or the performance of one or more players who participated in the sporting event, (d) providing one or more prizes to one or more attendees located at the sporting event for correctly guessing the outcome of the sporting event or the performance of one or more players who participated in the sporting event.

In yet another embodiment, a system for providing one or more benefits to one or more attendees of a sporting venue is provided. The system comprises (a) a computer readable medium or one or more computers for receiving a first piece of information from the input device of one or more attendees indicating or confirming that the one or more attendees are located at the sporting venue where the sporting event is taking or is about to take place, (b) a computer readable medium or one or more computers for sending information about the sporting event at the sporting venue to the input device of the one or more attendees located at the sporting venue, (c) a computer readable medium or one or more computers for receiving a second piece of information from the input device of the one or more attendees located at the sporting venue regarding the outcome of the sporting event or the performance of one or more players who participated in the sporting event and (d) a computer readable medium or one or more computers for determining the recipient of one or more prizes to one or more attendees located at the sporting event for correctly guessing the outcome of the sporting event or the performance of one or more players who participated in the sporting event.

In yet another aspect of at least one embodiment, the system further requires the computer readable medium or one or more computers receive the second piece of information before the sporting event begins.

### BRIEF DESCRIPTION OF THE DRAWINGS

FIG. 1 shows a diagram depicting how the components of at least one embodiment interact with one another.

FIG. 2 shows a diagram depicting a startup menu interface.

FIG. 3 shows a diagram depicting a display for attendee profile information input.

FIG. 4 shows a diagram of the “Register” interface, in which attendees will register their information with the network.

FIG. 5 shows a diagram of the main menu for the system and methods.

FIG. 6 shows a diagram depicting the customizable settings interface.

FIG. 7 shows a diagram depicting the embodiment that will allow attendees to select the stadium of attendance once they are within the network.

FIG. 8 shows a diagram depicting one embodiment that displays the game rules.

FIG. 9 shows a diagram depicting the various pre-game picks that attendees may select while attending a baseball game.

FIG. 10 shows a diagram depicting the various pre-game picks that attendees may select while attending a baseball game.

FIG. 11 shows a diagram depicting the various pre-game picks that attendees may select while attending a baseball game.

FIG. 12 shows a diagram depicting the various in-game picks that attendees may select while attending a baseball game.

FIG. 13 shows a diagram depicting the various in-game picks that attendees may select while attending a baseball game.

FIG. 14 shows a diagram depicting the various in-game picks that attendees may select while attending a baseball game.

FIG. 15 shows a diagram depicting the various pre-game picks that attendees may select while attending a basketball game.

FIG. 16 shows a diagram depicting the various in-game picks that attendees may select while attending a basketball game.

FIG. 17 shows a diagram depicting the various pre-game picks that attendees may select while attending an American football game.

FIG. 18 shows a diagram depicting the various in-game picks that attendees may select while attending an American football game.

FIG. 19 shows a diagram depicting the various pre-game picks that attendees may select while attending a football (soccer) match.

FIG. 20 shows a diagram depicting the various in-game picks that attendees may select while attending a football (soccer) match.

FIG. 21 shows a diagram depicting the various pre-game picks that attendees may select while attending a hockey match.

FIG. 22 shows a diagram depicting the various in-game picks that attendees may select while attending a hockey match.

FIG. 23 shows a diagram depicting the various pre-game picks that attendees may select while attending a golf tournament.

FIG. 24 shows a diagram depicting the various in-game picks that attendees may select while attending a golf tournament.

FIG. 25 shows a diagram depicting a system in accordance with another embodiment of the present disclosure.

FIG. 26 shows a diagram depicting the viewable “Game Status” interface, which is a display of the attendee's current point allocation.

FIG. 27 shows a diagram depicting the viewable game prizes that may be one by any participating attendee.

FIG. 28 shows a diagram depicting the leaderboard interface for the rankings of the attendees.

FIG. 29 shows a diagram of the interface which gives attendees the ability to order food, souvenirs, and other items from their seat using the system and method.

FIG. 30 shows a diagram of the interface depicting the legal terms of agreement viewable by attendees.

### DETAILED DESCRIPTION

In one embodiment of the present disclosure, the method is practiced using a mobile device, such as a mobile phone. In one embodiment, the application operates off of the Apple iPhone and is written using Apple's XCode and Objective. It should be noted that the present invention is adaptable for use on any operating system, including, but not limited to, Android, Apple, Windows, Linux, using any known code or operating system. In another embodiment, the system and method of the present disclosure provides a network interface which can be accessed on an input device (e.g., a mobile phone, tablet, kiosk or desktop computer) that provides the attendee with the ability to connect attendees of a sporting event, via an online network, to create an exclusive community of people attending the sporting event. The system and method allows the attendees to interact with one another, make selections regarding the players in the sporting event, other in-game events, or the outcome of the sporting event. In turn, participants may be eligible to receive prizes or exclusive content that include, but are not limited to, cash, prizes, discounts, coupons, incentives, tickets, targeted advertising, or promotional materials. In the preferred embodiment the application is free to download by users with the option to pay a nominal fee to remove advertising from the application.

Characteristics that are distinguishable between other system and methods, such as those dealing with fantasy sports and the system and method of the present disclosure include, but are not limited to, the fact that attendees must be located at the sporting event in order to use the system and method and participate in competing against other attendees for various special offers and prizes. One of the benefits of this disclosure is that it provides attendees of the sporting event with a better, more enjoyable experience at the sporting event and creates additional incentive for the attendee to attend the sporting event earlier, stay longer, and to return to see additional sporting events at the venue. The sporting event can be any sport. It should be appreciated that the methods and systems of the present invention can be used to along with any game, sporting or otherwise, and includes but is not limited to, golf, hockey, football, basketball, baseball, soccer, boxing, MMA, race car driving, swimming, water polo, skiing, snowboarding, bowling, Olympic sporting events, horse racing, tennis, rugby, and cricket, among others.

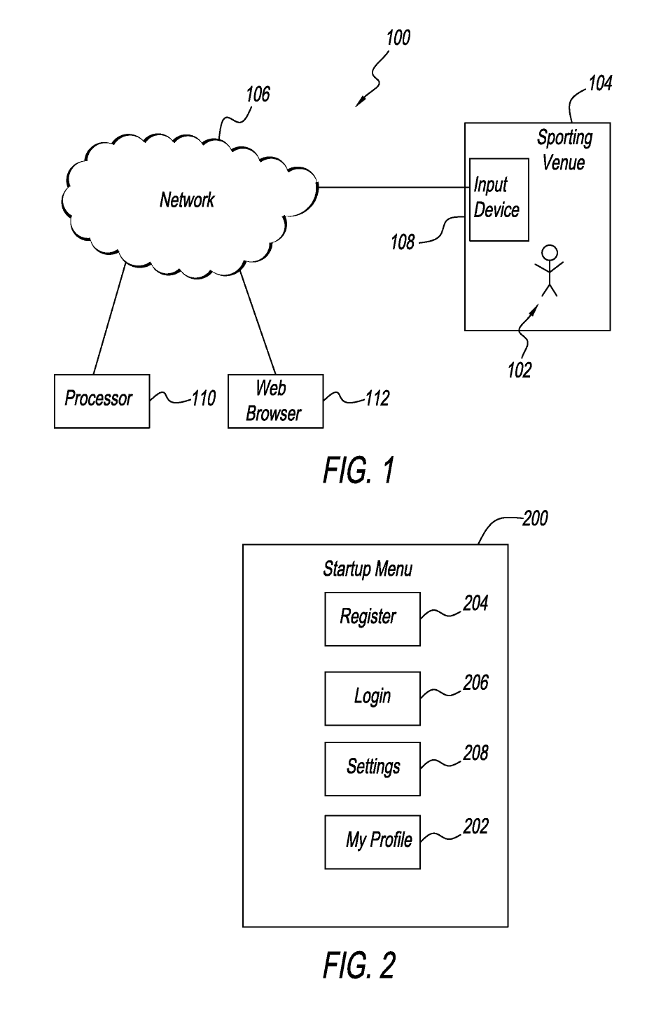

The term “attendee” is used throughout this disclosure to refer to people that are present at the sporting event venue at the time the particular event (sporting or otherwise) is taking place. FIG. 1 shows a diagram of a system and method 100 working in accordance. Once the attendee 102 is located within sporting venue 104, the attendee will access to the network 106 setup by the system and method using both the input device and the application. When the application starts, in one embodiment, it determines whether this is the first time it has been used, or whether it has been used before. If this is the first time the application is being used, then the user must register the device. The user registers by supplying his email address and a password, or other login information from a third-party service such as Facebook or Twitter, to the server through the device and the application. In one aspect of at least one embodiment, when an application is registered, the local CoreData services store a copy of the token and authentication IDs in order to allow easy verification later. If the user chooses to login, he has to enter the email and password he specified during his initial run. Several field verifiers are in place to sanitize the information as it is passed from server to server.

After the user fills out the required information and any optional information, such as his favorite team or an identifying photo, the device sends the server a POST request. The preceding information is encoded using JSON and the file as a multipart attachment. The server then parses the results, stores the file, and returns the new userID to the user. At the same time, JSON-encrypted updates are also delivered to the device. The updates correspond to each version of information contained within the application (i.e. Team Info, Stadium Info, Player Info, etc.). Versioned images of the team/stadium/players can also be retrieved if available.

After successful login/registration, the attendee is then eligible to participate in the contest via an input device 108. The system and method comprises of a processor 110 that allows eligible attendees to use the interactive game interface to make predictions as to the outcomes of the game and individual player performances. In order to do this, the device must acquire information about the event. In one aspect of at least one embodiment, the device accomplishes this by sending out a request to the server that looks up the location and time of the device and returns the event that matches the information provided in the request. The server will then cross reference the deviceID+time+token and return with the current game information, including: Stadium Information, Team Information, Player Information, and Game Information. All the aforementioned information is bundled in a JSON response which is then converted into an NSDictionary object for easier handling.

It should be appreciated that it is within the scope of the present invention to replace the deviceID+time+token arrangement by a Bluetooth-based APN verification at a concession stand or other location at or near the sports venue. This will require the device to activate itself, thus disclosing the location of the user and acquiring the aforementioned game information. Like the deviceID+time+token system, the BluetoothAPN PIN+deviceID combination will also return with the current game information (i.e. Stadium Information, Team Information, Player Information, and Game Information), which will also all be bundled in a JSON response which is then converted into an NSDictionary object for easier handling.

Once registered, the attendee is able to login 206 and also customize settings 208. Using the system and method, attendees also have the ability connect to the web via the input device's online web browser 112. Another beneficial aspect of the system and method of the present disclosure is it allows attendees to become more involved with the game and prove their knowledge of sports against other attendees located at the same game and received benefits and advantages while doing so.

FIG. 2 shows a diagram of one embodiment, of the present disclosure, that initially provides a startup menu 200, which supplies the attendee with the option to login 206, adjust the settings of the device 208, or create a personal profile under “My Profile” 202 and then register the profile 204.

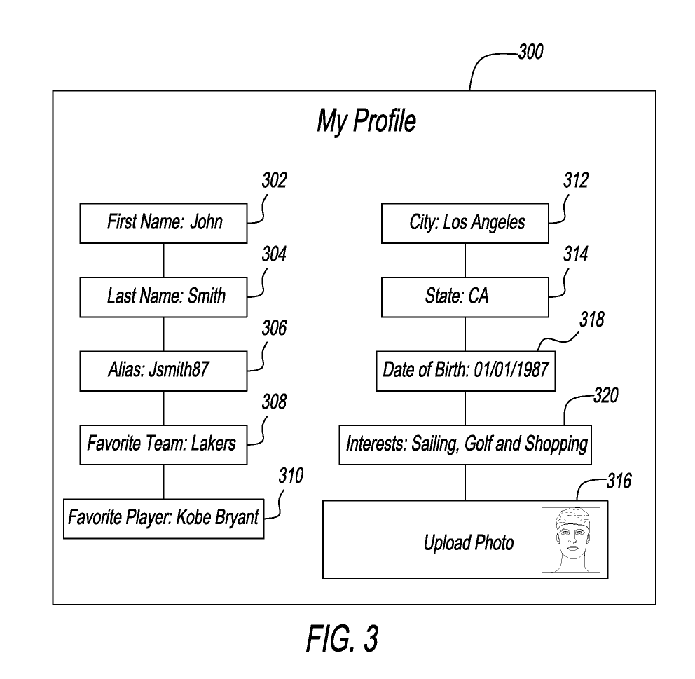

In FIG. 3, a diagram depicts yet another embodiment of the system and method, of the present disclosure. This embodiment calls for the creation of a profile 300 so that each attendee may register for online participation of the system and method. The attendee has the ability create a profile that indicates information the attendees is willing to offer including, but not limited to: the attendees' name 302, 304, an alias 306, favorite team 308 and player 310, city 312 and state 314, a profile photo 316, date of birth 318, and various interests and hobbies 320. Also, after the user logs in, he can change his profile information. This information is synced to the server and stored using Apple's CoreData library stack.

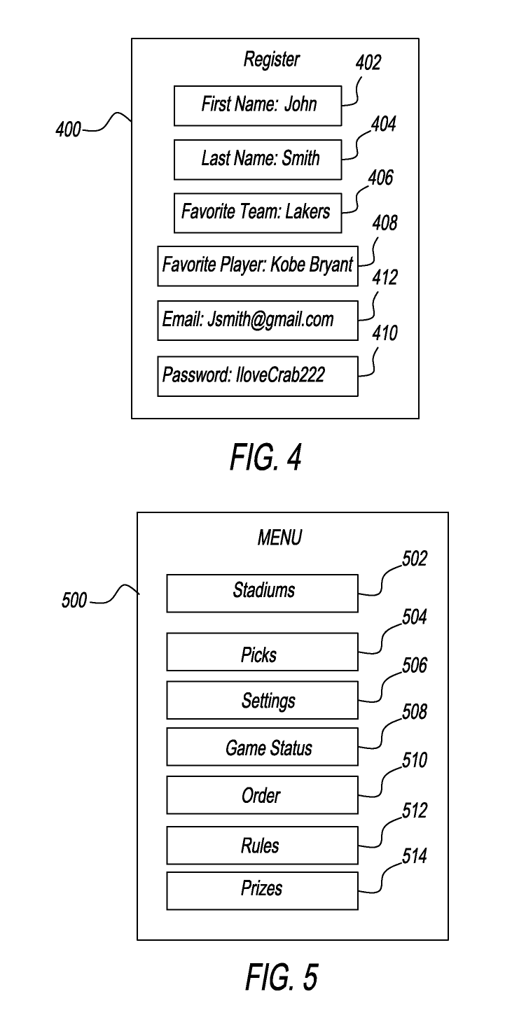

FIG. 4 shows a diagram of yet another embodiment, in which attendee has the ability to access the Register interface 400 and review the information provided in the profile 300 option including First Name 402, Last Name 404, favorite team 406 and player 408 and additional information. The attendees will then create a password 410, unique to the system and method of the present disclosure, in order to keep the profile and the information private. Attendees may also register an email address 412. This information will then be registered with the system and method's network so that this profile will be accessible only by its respective attendee.

FIG. 5 is a diagram of yet another embodiment of the present disclosure, in which the attendee has the ability to access a “Main Menu” 500, in which the attendee has several different options of selection. The main menu is comprised of two parts: the top navigation and the bottom tabbed quick nay. Top buttons open up a new screen upon tap, whereas the tabs slide to the appropriate sub module. Bottom navigation allows user to quickly reach parts of the application which are commonly used, including but not limited to the user's pre-game and in-game picks, the users' standing relative to other users at the event, and a page for ordering concessions. From the main menu, the attendee may select the appropriate stadium of attendance 502, select the picks 504 the attendee wishes to make, customize the settings 506, check the status of the game 508, order food and other items 510, read the rules 512 of the game, and see the available prizes 514 for winning.

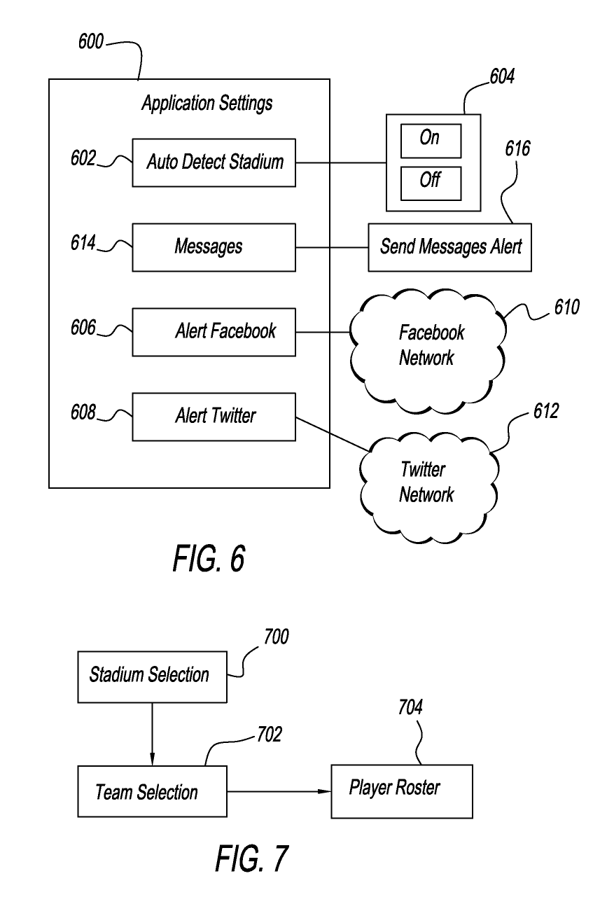

Once the attendee has created and registered a profile, FIG. 6 displays a separate embodiment that allows the attendee to customize the system and method's settings 600 to suit the attendee's desires. The settings give the attendee the option of automatically detecting the stadium 602 that the attendee is attending. By turning this feature on 604, the system and method will automatically detect the stadium on rather than the attendee having to manually select the stadium. The device accomplishes this through the system and method described in paragraph herein. The settings also enable automatic Facebook 606 and/or Twitter 608 alerts by connecting to their respective networks 610, 612. For example, attendee's may update their Facebook and/or Twitter account(s) to notify others that the he or she is in attendance of the sports game, participation with the system and method, and their overall performance. Further, the messages 614 option, which gives the attendee the ability to receive messages 616 for various notifications as well as communication with other attendees at the sporting event, may also be enabled. The present disclosure also provides the attendees to communicate and interact with each other, through a social media site like Facebook or independent of any other site or service.

Restrict participation to people in attendance of the sporting event creates a unique social community during the course of the game for attendees to compete among one another for various benefits and prizes. The system and method of the present disclosure calls for the attendee to be present at the venue of the sports game. Once the attendee is located within the network, the system and method of the present disclosure will identify the attendees' internet-connected, input device and allow the attendee to utilize the systems and methods described herein.

FIG. 7 shows another embodiment 700, in which the attendee will then select the appropriate stadium according to the respective city that the attendee has indicated. Following this, the teams 702 participating in the sporting event will appear on the interactive interface and allow the attendee to make pre-game and in-game picks based on various predictions. The attendees are then able to individually select specific players from each team's roster 704 and make various picks, before and during the game, according to their predicted outcomes. The competition between the attendees is a point based system that awards points to the attendee based upon the number of accurate predictions the user makes regarding at bat events, pitching, and the game's score. The picks page collects the information of the given user's picks made against the current game in question. It displays the total points they have and how many in game and pre-game picks they had. This page is synced with the central server upon each load to ensure that the data is always up to date. To make a pick, the user simply selects the team they wish to use, followed by the player they wish to use. The system tracks each total for the items during the drilldown. At the final step, the user will select what type of at bat event they wish to set. When this is saved, it is pushed to the server.

The server stores this pick information and will know who to notify with points upon an at bat event. All pick pages now send over the current pick queue to ensure data integrity and High Availability. This will be optimized more to send over delta data to reduce the network overhead. The server can and will, from time to time, respond with events that will trigger updates on the screens. The system will bring the sporting event to life and allow attendees to interact with it.

The system and method of the present disclosure creates a computer-based network allowing attendees to interact with the live events. There are 2 major event types in the system: Game related and Ad related. The event pages themselves communicate with each other using the Apple Internal Messaging system and respond to events triggered by APNS (Apple Push Notification Services). Whenever an event occurs, the application relays the request to the proper class. Each event triggers a different reaction inside the application.

Game related events include the beginning of a game, the end of a game, and an at-bat event. For instance, a game start will switch the pre-game mode over to the in-game mode, sending all future picks the user will make to the in-game mode. The at-bat event triggers a point update request on clients to get the results from the server and update their displays. Currently, the at-bat events request the full pick results for the given user to comply with High Availability, but can be reduced later to only send packets that are affected.

In ad-related events, the system allows the clients to receive ad display requests over APNS. This will trigger a screen to display an ad on all participating phones or other input device. This screen has a timer, which shows the remaining display time. In one embodiment, quitting the application or waiting for the timer to go down is the only way to close this page.

Attendees are able to access this network using a variety of different internet capable devices including: smartphones, tablets, laptops, kiosks, and desktop computers.

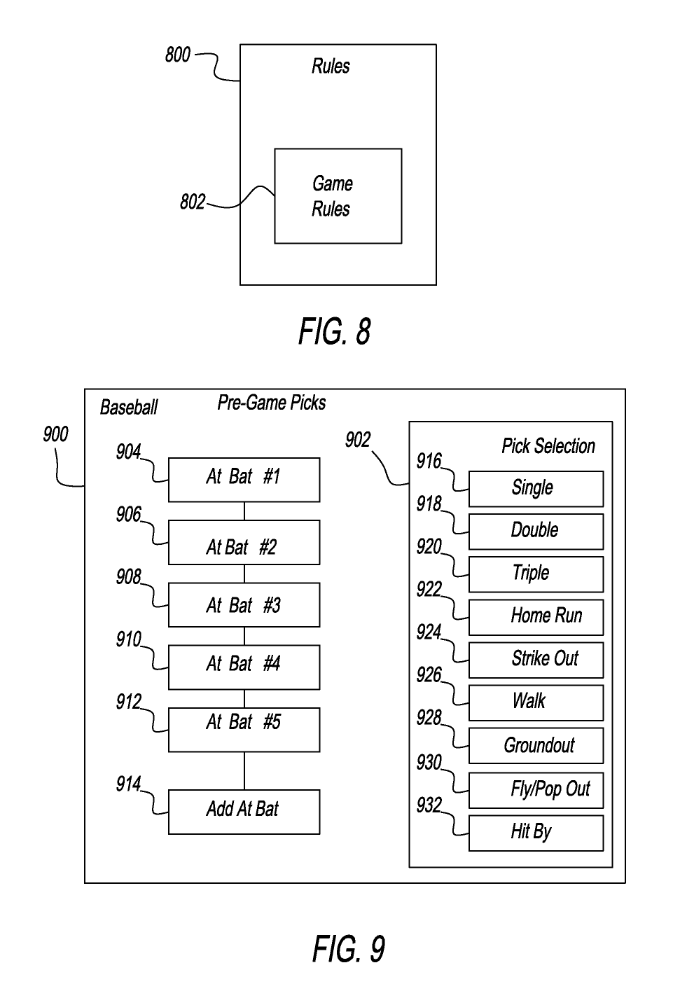

FIG. 8 shows a diagram of an embodiment 800 that can be accessed within the main menu 500. The system and method of the present disclosure provides a Rules interface that explains the rules of the game 802 for attendees to follow in order to correctly participate in the contests.

The system and method allows for attendees to make various pre-game picks, which will be awarded more points, or in-game picks for points that will be awarded according to the accuracy of the picks. All of the participating attendees will then be ranked accordingly. Attendees may search for an alias, such as a friend or family member, that is also in attendance by using a search engine that the system and method offers or by sending invitations using the attendee's Facebook (or Twitter) account(s). This allows the attendee to compete on both a global scale as well as personally among friends and family.

In an alternative embodiment, the system and method contains numerous children's games that are simplified or unrelated to the statistical performances of players or the outcome of the game. Examples include, but are not limited to, picking the winner of a simulated race, guessing games referring to icons or markers throughout a stadium, or guessing where foul balls will land in a baseball game. The children's games can either be incorporated into the adult version of the game, or separated into its own downloadable application.

FIG. 9 is a diagram of one embodiment 900, in which the system and method allows for baseball game attendees to make various pre-game picks for different aspects of the game. The picks page operates in a similar manner to that described herein. 902 Pre-game picks include, but are not limited to, whether the batter 904 to 914 will hit a single 916, double 918, triple 920, home run 922, strikeout 924, walk 926, a groundout 928, a fly-out/pop-out 930, or a hit by 932.

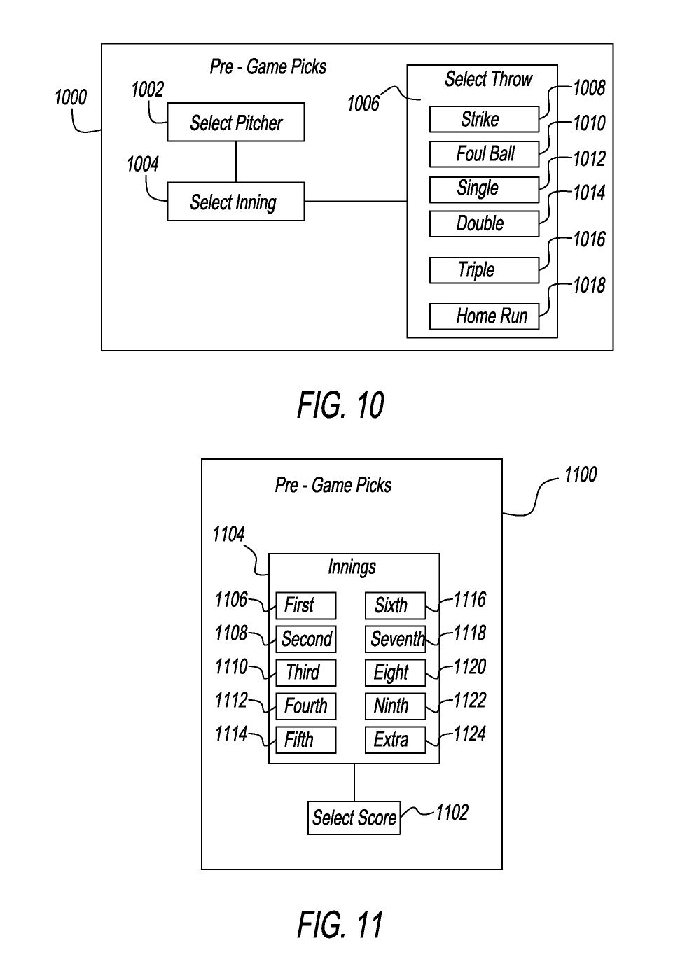

FIG. 10 is a diagram of another embodiment 1000, where the attendee can select individual pitchers 1002 per inning 1004 and make pre-game picks as to whether the pitcher will throw 1006 a strike 1008, a foul ball 1010, a single 1012, double 1014, triple 1016, or home run 1018 during the course of the selected inning.

FIG. 11 is a separate embodiment 1100 that allows the attendees to make pre-game predictions as to the score 1102 at the end of each inning 1104 to 1124 as well as the final score of the game.

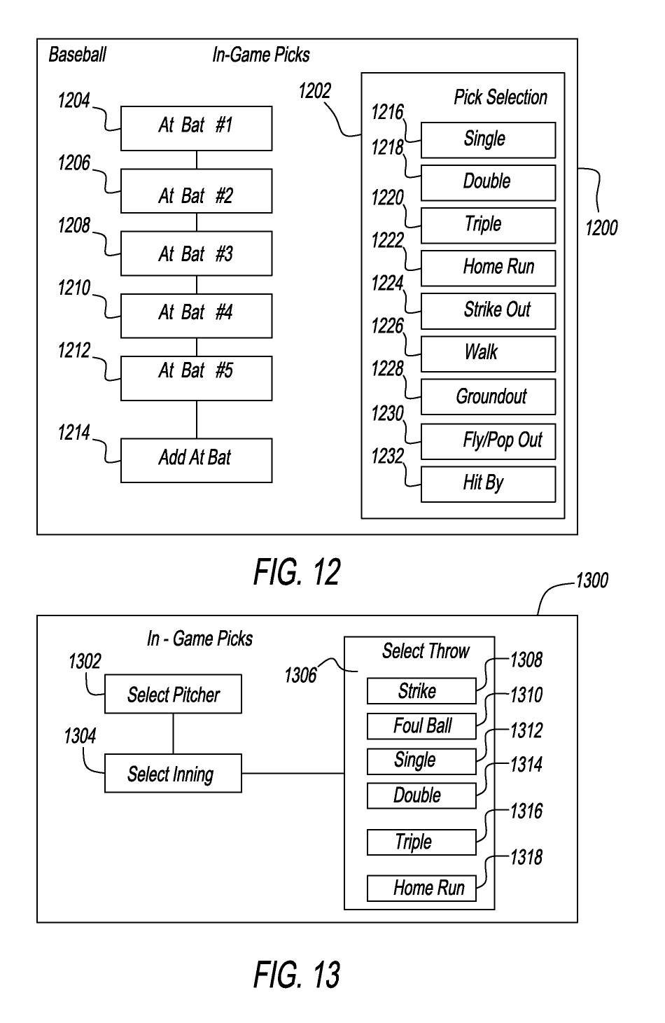

FIG. 12 is a diagram of a separate embodiment 1200. Here, the system and method allows for baseball game attendees to make various in-game picks for different aspects of the game. 1202 In-game picks include, but are not limited to, whether the batter 1204 to 1214 will hit a single 1216, double 1218, triple 1220, home run 1222, strikeout 1224, walk 1226, a groundout 1228, a fly-out/pop-out 1230, or a hit by 1232.

FIG. 13 is a diagram of another embodiment 1300, in which the attendee can select individual pitchers 1302 per inning 1304 and make in-game picks as to whether the pitcher will throw 1306 a strike 1308, a foul ball 1310, a single 1312, double 1314, triple 1316, or home run 1318 during the course of the selected inning.

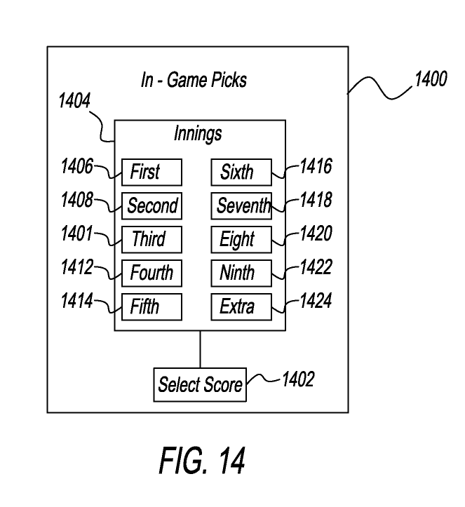

FIG. 14 is a diagram showing a separate embodiment 1400 that will allow the attendees to make in-game predictions of the score 1402 at the end of each inning 1404 to 1424 as well as the final score of the game.

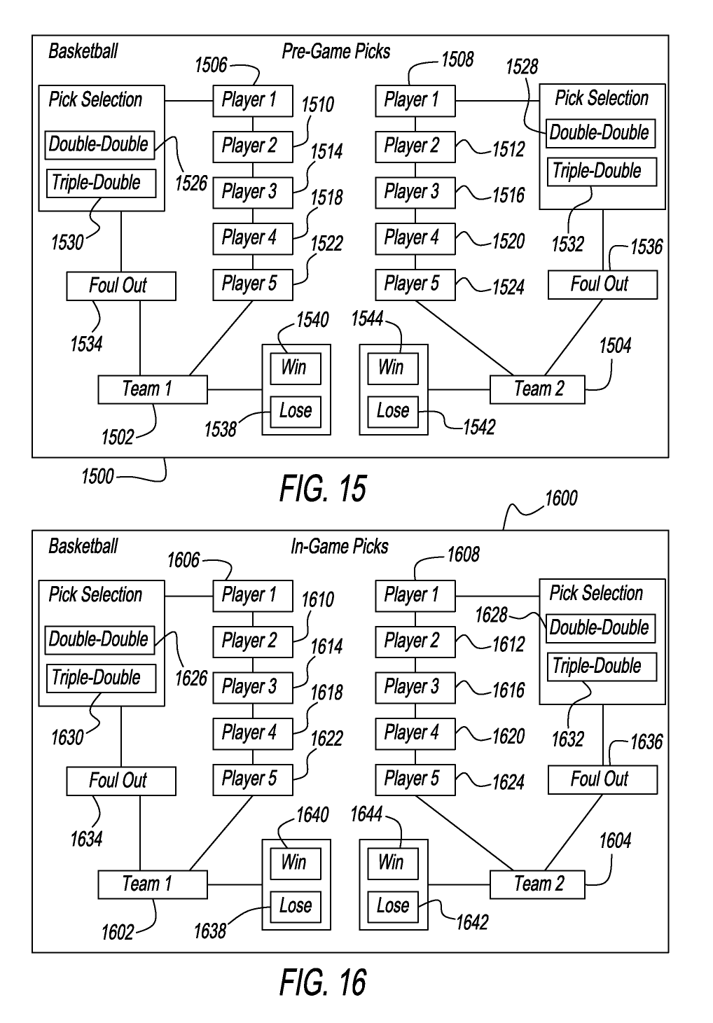

FIG. 15 shows a diagram of an alternate embodiment 1500, in which basketball game attendees are able to make pre-game picks for each team 1502, 1504 including, but not limited to, whether each player 1506 to 1524 will have a “double-double” 1526, 1528, “triple-double” 1530, 1532 or foul out 1534, 1536 during the course of the game. Also, the attendee has the ability make picks as to the ultimate winner and/or loser 1538 to 1542 of the sporting event or predict the score at the end of the game or quarters.

FIG. 16 is a diagram of a separate embodiment 1600, showing how basketball game attendees are able to make in-game picks for each team 1602, 1604 including, but not limited to, whether each player 1606 to 1624 will have a “double-double” 1626, 1628, “triple-double” 1630, 1632 or foul out 1634, 1636 during the course of the game. Also, the attendee has the ability make picks as to the ultimate winner and/or loser 1638 to 1642 of the sporting event or predict the score at the end of the game or quarters.

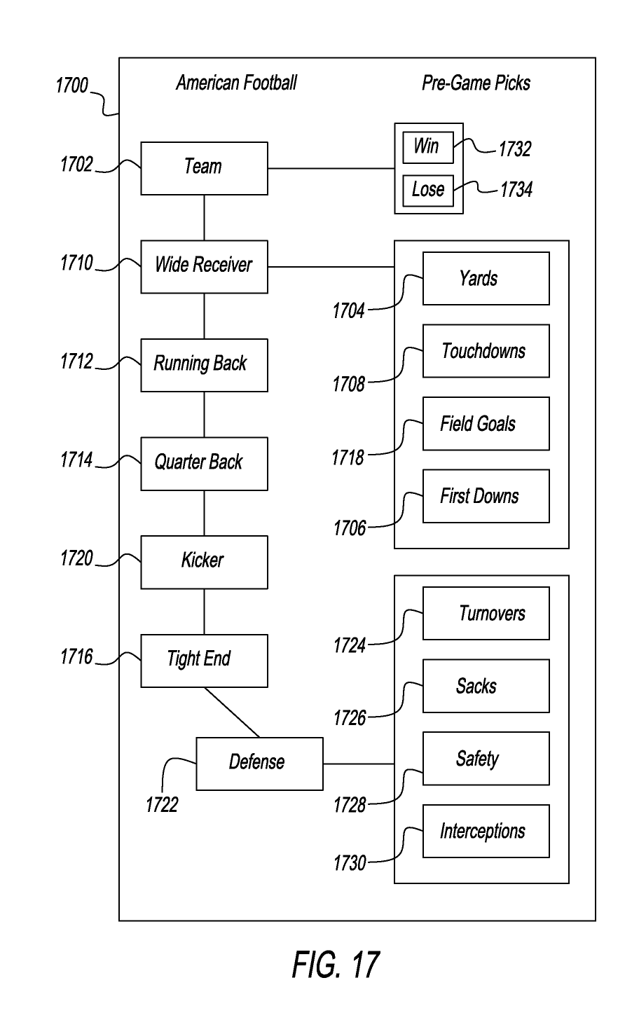

FIG. 17 is a diagram depicting another embodiment 1700, in which the system and method allows American football game attendees to select pre-game picks for almost every aspect of the sporting event. Possible picks for each team 1702 include but are not limited to the approximate amount of yards 1704, first downs 1706 and touchdowns 1708 for wide receivers 1710, running backs 1712, quarterbacks 1714, and tight ends 1716; field goals 1718 by kicker(s) 1720. For the defense 1722, attendees have the ability to make picks for turnovers 1724, sacks 1726, safeties 1728, and interceptions 1730. Attendees are also able to decide which team will win or lose 1732, 1734 or predict the score at the end of the game or periods.

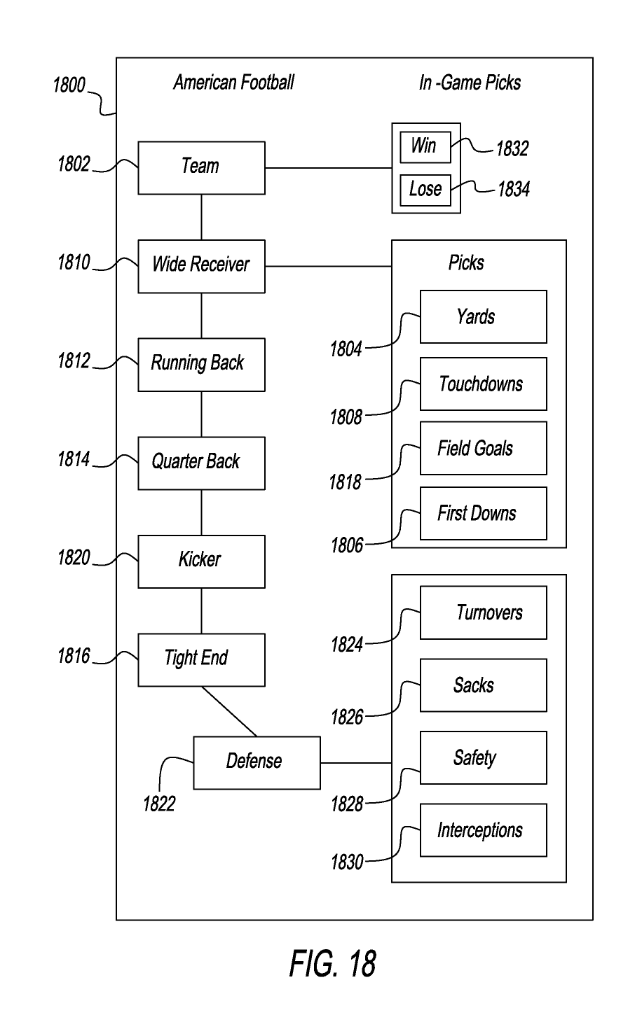

FIG. 18 is diagram of a separate embodiment 1800. Here, the system and method allows American football game attendees to select in-game play-by-play picks for almost every aspect of the sporting event. Possible picks for each team 1802 include but are not limited to the approximate amount of yards 1804, first downs 1806 and touchdowns 1808 for wide receivers 1810, running backs 1812, quarterbacks 1814, and tight ends 1816; field goals 1818 by kicker(s) 1820. For the defense 1822, attendees have the ability to make picks for turnovers 1824, sacks 1826, safeties 1828, and interceptions 1830. Attendees are also able to decide which team will win or lose 1832, 1834 or predict the score at the end of the game or periods.

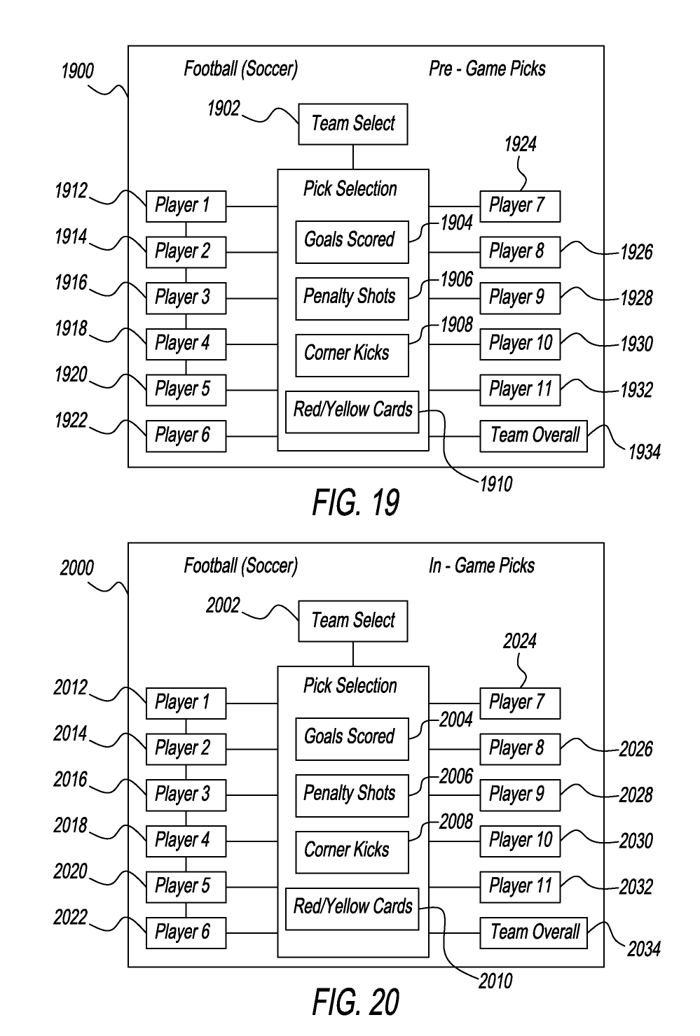

FIG. 19 is a diagram depiction of one embodiment 1900 where attendees of a football (soccer) match have the ability to make pre-game picks for each team 1902 regarding almost every aspect of the game including, but not limited to, how many goals will be scored 1904, penalty shots 1906, corner kicks 1908, and red and yellow cards 1910 received for 1912 to 1932 each player and the overall team 1934.

FIG. 20 shows a diagram depiction of another embodiment 2000. Here attendees of a football (soccer) match will be able to make in-game picks for each team 2002 regarding almost every aspect of the game including, but not limited to, how many goals will be scored 2004, penalty shots 2006, corner kicks 2008, and red and yellow cards 2010 received for 2012 to 2032 each player and the overall team 2034.

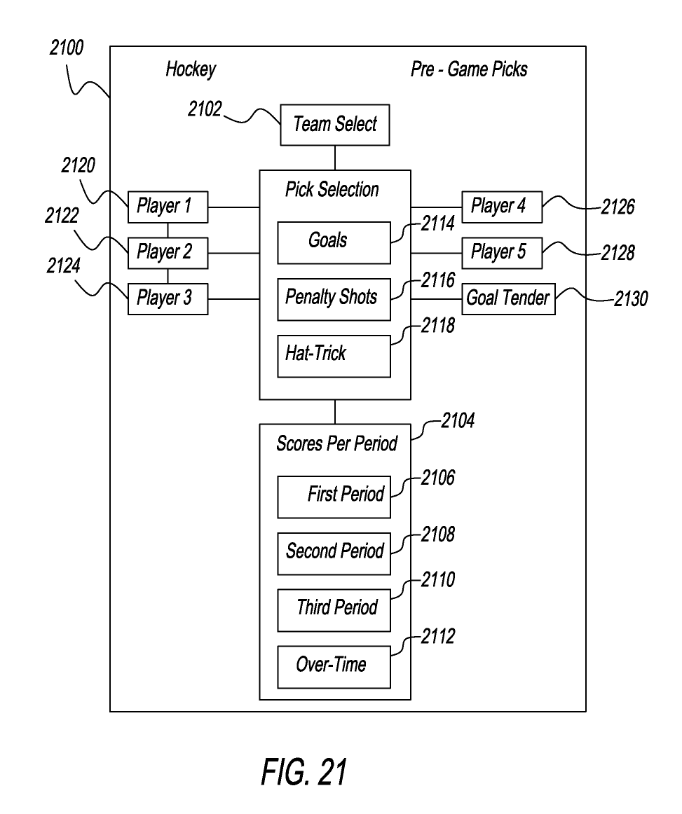

FIG. 21 is a diagram of one embodiment that 2100 involves attendees of a hockey match. Attendees have the ability to make pre-game picks for each team 2102 regarding, but not limited to, the scores for each period 2104 to 2112, the amount of goals 2114, penalty shots 2116, and hat-tricks 2118 by each player 2120 to 2130 during the match. Attendees are also able to decide which team will win or lose or predict the score at the end of the game.

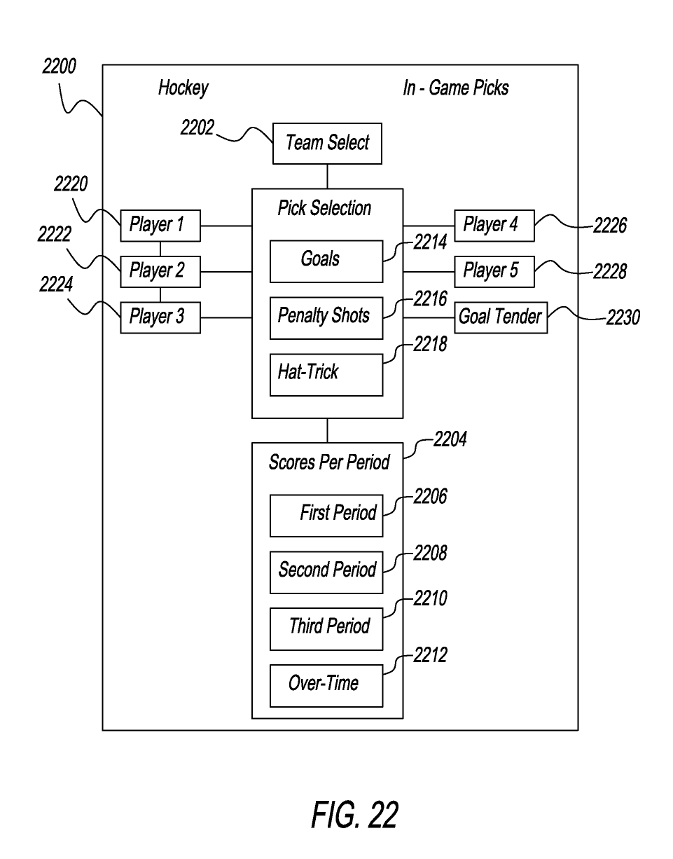

FIG. 22 shows a diagram of a separate embodiment 2200 that involves attendees of a hockey match. Attendees have the ability to make in-game picks for each team 2202 regarding, but not limited to, the scores for each period 2204 to 2212, the amount of goals 2214, penalty shots 2216, and hat-tricks 2218 by each player 2220 to 2230 during the match.

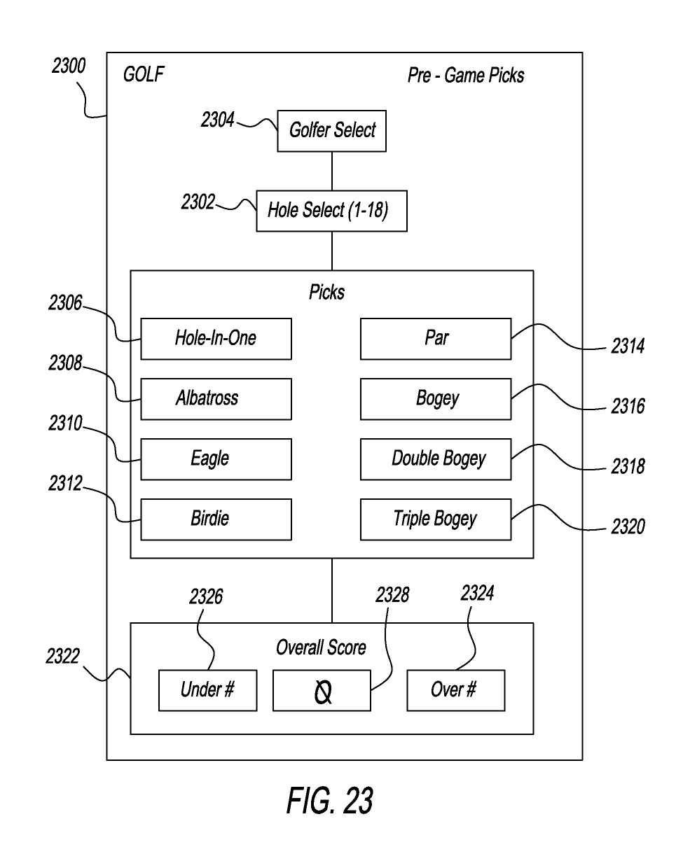

For golf match attendees, FIG. 23 shows a diagram of one embodiment 2300 that allows the attendee to make pre-game picks on every hole 2302 for each golfer 2304 in the tournament including, but not limited to, whether the golfer would get a hole-in-one 2306, an albatross 2308, an eagle 2310, a birdie 2312, par 2314, bogey 2316, double bogey 2318 or triple bogey 2320. Attendees also have the ability to predict each golfer's overall score 2322, whether it be over par 2324, under par 2326, or even par 2328.

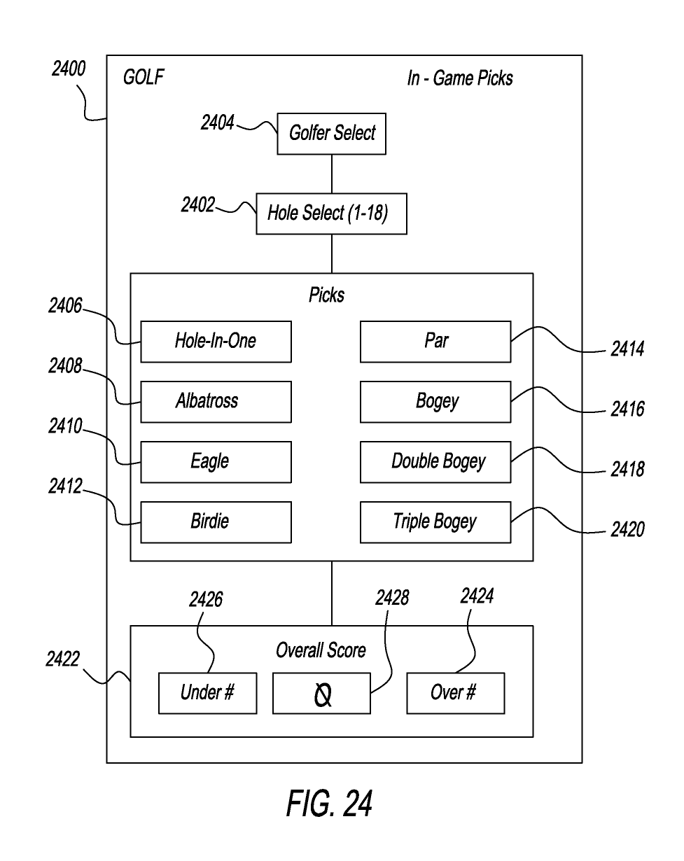

For golf match attendees, FIG. 24 shows a diagram of a separate embodiment 2400 that allows the attendee to make in-game picks on every hole 2402 for each golfer 2404 in the tournament including, but not limited to, whether the golfer would get a hole-in-one 2406, an albatross 2408, an eagle 2410, a birdie 2412, par 2414, bogey 2416, double bogey 2418 or triple bogey 2420. Attendees also have the ability to predict each golfer's overall score 2422, whether it be over par 2424, under par 2426, or even par 2428.

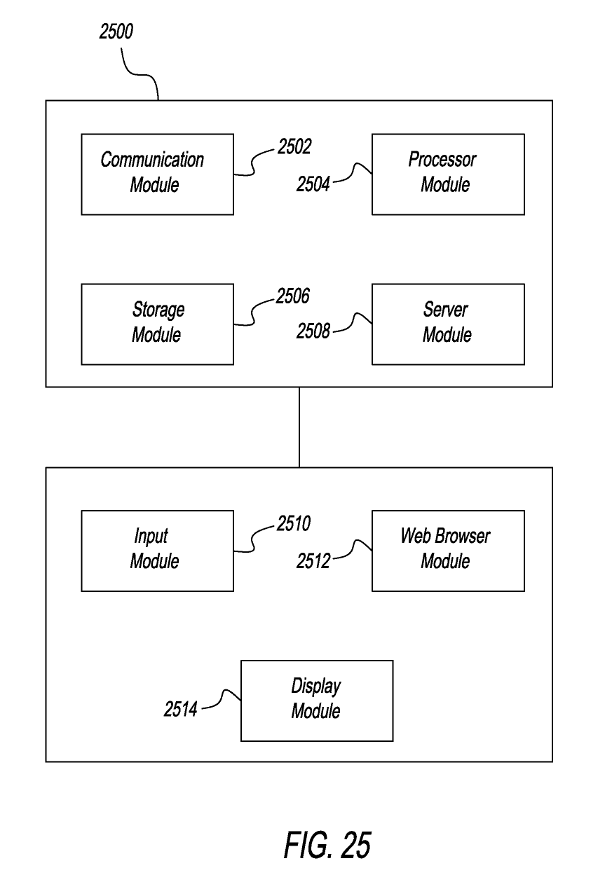

FIG. 25 shows a diagram one embodiment 2500 that depicts how each of the individual modules work together in occurrence. Here, the communications module 2502 works in accordance with the processor module 2504 and allow attendees to connect to the system and method network 106 using their input devices. The storage module 2506 will also be connected so that information can be stored to the server module 2508, which is connected under the same network 106.

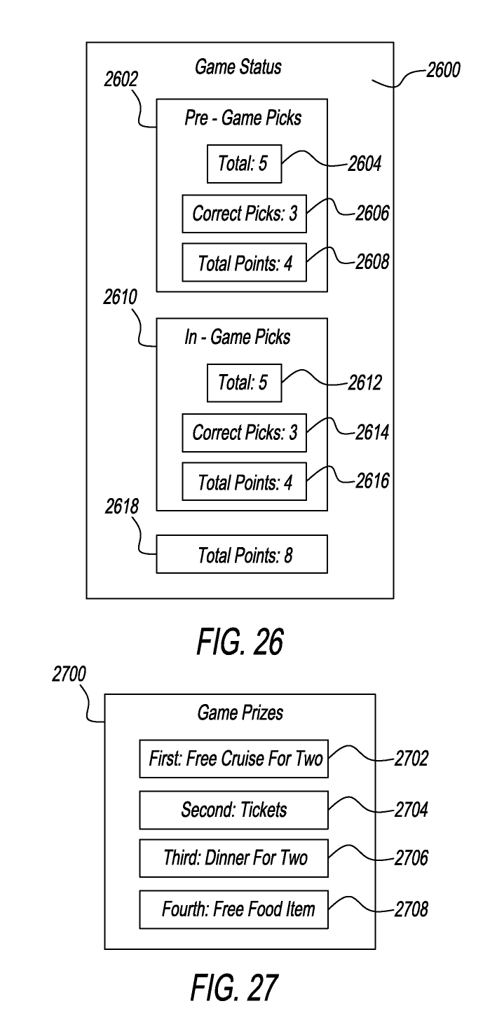

Each attendee's input device will allow the system and method to connect the input module 2510 to the network and allow access to the internet via the input device's web browser module 2512. The input device operates in the same manner as described herein. The input device's display module 2514 will allow the attendee to view the systems and methods described herein. The system and method of this present disclosure allows for the attendee to constantly check their game status, which is found among the main menu 500 options. FIG. 26 is a diagram of one embodiment that depicts the game status embodiment 2600 gives the attendee a breakdown of several attendee statistics. This game menu contains the Stadium information, the Teams, date, time and remaining time till start. Each section has an action assigned to it, which allows the users to get more information on the given item (e.g. the biography of a player on a team with photos). In addition, there is a green progress meter at the bottom, which shows the time remaining until the start of the game. These pre-game statistics 2602 include, but are not limited to, the amount of pre-game picks made 2604, the correctly made 2606 pre-game picks and the total points 2608 allocated with the correct pre-game picks made. The attendees are also have the ability to view their in-game statistics 2610, which include, but not limited to, the amount of in-game picks made 2612, the correctly made 2614 in-game picks and the total points 2616 allocated with the correct in-game picks made. All of these points are then totaled to give the attendee an overall points score 2618.

FIG. 27 shows a diagram of the prizes menu, which shows the prizes associated with the game. These a another embodiment 2700, in which the attendee may view the available game prizes to be won for first place 2702, second place 2704, third place 2706, fourth place 2708, and more. Prizes may include, but are not limited to: tickets to future games, opportunities to meet future players, complimentary food and/or souvenir items, coupons, vacation getaway packages, and gift cards. This content is retrieved from the game activation along with the images. Images are retrieved using GET commands bundled with the authentication token and DeviceID in order to avoid illegal exploitation.

The system and methods, of the present disclosure, will also offer exclusive features available for attendees that participate in the interactive sporting game experience. Such features may include, but are not limited to, exclusive pre-game, halftime, and/or post-game locker-room interviews with team players, updated reports regarding the latest sports news, and more.

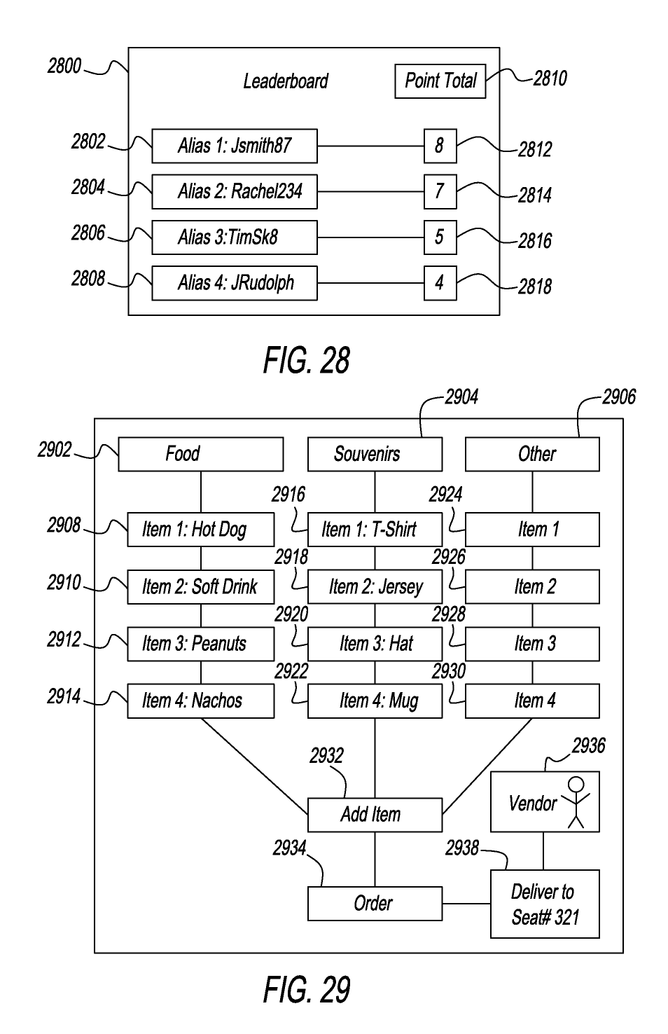

A standings screen contains the cumulative overall standings spanned throughout the users participating in the game. Since each pick is awarded points (or none if the pick was incorrect) the system can chart the players on a top list. The system will also show what position the given player is at the bottom of the screen. You can also search for a given position by entering it on the top search bar. The format of the packet is the same throughout the system, JSON encoded maps which are then converted to associative arrays on the server side. FIG. 28 shows a diagram of the standings screen as a separate embodiment 2800 that allows for the attendees to view a “Leaderboard” depicting 2802 to 2808 the attendees' alias and respective ranking based on most points awarded 2810 to 2818 among other attendees within the sporting venue for that particular sporting event. Depending on the amount of correctly made pre-game and/or in-game picks, the system and method will calculate the equivalent amount of points and automatically rank the attendee on a “leaderboard” along with the other participating attendees. The leaderboard will also display each attendees' overall ranking against all others that use this same system and method described in this present disclosure. This gives the attendee the opportunity to compare their own performance against friends, family, and all other past and present attendees.

FIG. 29 shows a diagram of one embodiment, 2900 in which the system and method of the present disclosure provides attendees of the sporting event with the ability to request certain available foods 2902, souvenirs 2904, and other items 2906 without having to leave their seats. The system and method of the present disclosure allows the attendee to select specific items 2908 to 2932 listed that are available for purchase. Once the attendee has selected the order 2934, the system and method provides the vendor 2936 with the attendee's seat 2938 where the items are to be delivered. For example, if an attendee attending a baseball game desires a bag of peanuts, the attendee may select “Order” 2934 from the menu screen and make an order for one of the available items (e.g., peanuts) to be delivered to the attendee's seat. This will bring about an overall benefit for both the attendees and the stadium. Without having to get up and wait in lines or until the vendor has come around to that particular section of the stadium, the attendees will feel more willing to make purchases while being immediately satisfied and never having to miss a minute of the game. This better serves the stadium because not only will sales go up due to more willing attendees to make purchases, but vendors will have a more efficient method of knowing who is in need of a purchasable item for sale and thus able to sell more items during the course of the sporting event.

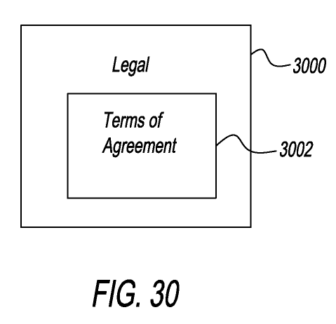

FIG. 30 shows a diagram of another embodiment 3000 that will display the relevant legal terms of agreement 3002 for the attendee's knowledge.

For boxing event attendees, one embodiment of the system and method allows the attendee to make pre-fight picks on the number of jabs each boxer will land, the number of power punches each boxer will land, the number of knockdowns each boxer will score, and whether a boxer will win by knockout or decision. If the match ends by knockout, the attendee may make pre-fight picks as to which round the knockout will occur. If the match goes to a decision, the attendee may make pre-fight picks as to how many points each boxer will accumulate per round and overall throughout the fight, as well as whether the decision will be a unanimous, split, or majority. The attendee may also make pre-fight picks as to whether a fight will end by a draw, no contest, disqualification, or by a technical decision. In the case of a draw, the attendee may make pre-fight picks as to whether the draw will be unanimous, split, or majority. In the case of a disqualification, no contest, or technical decision, the attendee may make in-fight predictions as to which round the match-ending foul will occur in.

In another embodiment of the system and method, the attendee may make in-fight picks on the number of jabs each boxer will land, the number of power punches each boxer will land, the number of knockdowns each boxer will score, and whether a boxer will win by knockout or decision. If the match ends by knockout, the attendee may make in-fight picks as to which round the knockout will occur. If the match goes to a decision, the attendee may make in-fight picks as to how many points each boxer will accumulate, as well as whether the decision will be a unanimous, split, or majority. The attendee may also make in-fight picks as to whether a fight will end by a draw, no contest, disqualification, or by a technical decision. In the case of a draw, the attendee may make in-fight picks as to whether the draw will be unanimous, split, or majority. In the case of a disqualification, no contest, or technical decision, the attendee may make in-fight predictions as to which round the match-ending foul will occur in.

For mixed martial arts event attendees, one embodiment of the system and method allows the attendee to make pre-fight picks on the number of standing strikes each fighter will land, the number of ground strikes each fighter will land, the number of takedowns each fighter will secure, the number of knockdowns each fighter will score, the number of submissions each fighter will attempt, and whether a fighter will win by knockout, submission, or decision. If the match ends by knockout or submission, the attendee may make pre-fight picks as to which round the knockout or submission will occur. In addition, if the fight ends by submission, the attendee may make pre-fight picks as to which submission the winning fighter will use. If the match goes to a decision, the attendee may make pre-fight picks as to how many points each fighter will accumulate, as well as whether the decision will be unanimous, split, or majority. The attendee may also make pre-fight picks as to whether a fight will end by a draw, no contest, disqualification, or by a technical decision. In the case of a draw, the attendee may make pre-fight picks as to whether the draw will be unanimous, split, or majority. In the case of a disqualification, no contest, or technical decision, the attendee may make pre-fight predictions as to which round the match-ending foul will occur in.

In another embodiment of the system and method, the attendee may make in-fight picks on the number of standing strikes each fighter will land, the number of ground strikes each fighter will land, the number of takedowns each fighter will secure, the number of knockdowns each fighter will score, the number of submissions each fighter will attempt, and whether a fighter will win by knockout, submission, or decision. If the match ends by knockout or submission, the attendee may make in-fight picks as to which round the knockout or submission will occur. In addition, if the fight ends by submission, the attendee may make in-fight picks as to which submission the winning fighter will use. If the match goes to a decision, the attendee may make in-fight picks as to how many points each fighter will accumulate, as well as whether the decision will be unanimous, split, or majority. The attendee may also make in-fight picks as to whether a fight will end by a draw, no contest, disqualification, or by a technical decision. In the case of a draw, the attendee may make in-fight picks as to whether the draw will be unanimous, split, or majority. In the case of a disqualification, no contest, or technical decision, the attendee may make in-fight predictions as to which round the match-ending foul will occur in.

For racing event attendees (i.e. stock car, Formula One, etc.), one embodiment of the system and method allows the attendee to make pre-race picks on the order of placers in the race. In addition, if a driver is forced to leave the race, the attendee may make pre-race picks as to what lap the driver will leave the race.

In another embodiment of the system and method, the attendee may make in-race picks on the order of placers in the race. In addition, if a driver is forced to leave the race, the attendee may make in-race picks as to what lap the driver will leave the race.

For tennis event attendees, one embodiment of the system and method allows the attendee to make pre-match picks as to the score of each game, the winner of each game, the score of each set, the winner of each set, and the winner of the match. Attendees will also be able to pick the number of aces, faults, backhands, winners, or penalties totaled during the match or by certain players. The aforementioned embodiment is applicable to both singles and doubles matches.

In another embodiment of the system and method, the attendee may make in-match picks as to the score of each game, the winner of each game, the score of each set, the winner of each set, and the winner of the match. Attendees will also be able to pick the number of aces, faults, backhands, winners, or penalties totaled during the match or by certain players. The aforementioned embodiment is applicable to both singles and doubles matches.

For horse racing event attendees, one embodiment of the system and method allows the attendee to make pre-race picks as to the winner of each race along with the number of furlongs each winner wins his race by. In addition, if a jockey/horse is forced to leave the race, the attendee may make pre-race picks as to which lap the horse leaves the race.

In another embodiment of the system and method, the attendee may make in-race picks as to the winner of each race along with the number of furlongs each winner wins his race by. In addition, if a jockey/horse is forced to leave the race, the attendee may make in-race picks as to which lap the horse leaves the race.

In yet another alternative embodiment, the methods and systems can be used at non-sports related events, such as, but not limited to festivals, concerts, county fairs, parades, demonstrations, or conventions. The system and method allows the attendees to interact with one another, make selections regarding the entertainers or hosts of the event, other real-time developments, or the outcome of the live event. In turn, participants may be eligible to receive prizes or exclusive content that include, but are not limited to, cash, prizes, discounts, coupons, incentives, tickets, targeted advertising, or promotional materials.

For all sports or entertainment events, the method and system can be used for interactive trivia games allowing for all attendees to participate. Trivia can relate to event-specific questions, player or entertainer questions, or general questions concerning the history or a sport. Simplified trivia questions can be incorporated into the children's version of the application. Results and answers for trivia questions can either be displayed through users' own devices or on in-stadium screens.

In another embodiment, the application will allow users to watch highlights or replays from the present game, other on-going games throughout the world, or past games. The application can also provide real-time statistics for the present game or other on-going games.

In yet another aspect of at least one embodiment, the second large module of the system is the backend server. The backend allows the administrators to edit users, stadiums, teams, players, at bat options, game options, and all other aspects of the game. This is a PHP driven system running on an Apache webserver. The persistence is handled by MySQL, but can be scaled to use any other database system if required. The backend was written using CodeIgniter to allow an MVC (Model - - - View - - - Architecture) approach. This allows code separation from the display. We use JSON and associative arrays to handle the communication as this allows a semi-transparent approach to platform independence. The backend also uses jQuery for the ajax related menu items and HTML/CSS for the graphics and layout displays.

The backend can also trigger the same game events described in paragraph [0053]. When an at bat event is triggered, the system looks up all registered devices that have come online. These phones are then notified using APNS with the proper parameters. After the at bat event, the system calculates who received points for a given pick and will update the standing database table accordingly.

In addition, the system allows HTML content to be added and displayed as advertisements on all participating devices. This can range from dynamic content, to videos all the way to animations. Whenever an ad event is triggered all devices will receive a page with the content loaded and a timer on the bottom. This timer will decrement until it reaches zero. After the timer has gone down the page is hidden automatically. This allows a centralized display of ads over multiple devices.

Using the attendee's provided information, the system and method of the present disclosure will portray advertisements that fit the attendee's interests throughout the attendee's game experience. The advertisement may depict an image, play audio, show a video, or display an advertisement in some other manner. The attendee will be able to select any of the advertisements where the attendee expresses interest in receiving more information. By clicking on the advertisement, the attendee's input device will be directed to an internet web site using the device's internet web browser. The web browser may be any type, including, but not limited to, Chrome, Safari, Microsoft Internet Explorer, Netscape Navigator, or any browser capable of connecting to the Internet.

While the systems, apparatus and methods have been described in terms of what are presently considered to be the most practical and preferred embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

1. A method of providing an electronic game and one or more benefits to one or more attendees of a sporting venue; the method comprising:
(a) receiving a first piece of information from the input device of one or more attendees located at a sporting venue where a sporting event is taking or is about to take place;
(b) sending information to the input device of the one or more attendees located at the sporting venue;
(c) receiving a second piece of information from the input device of the one or more attendees located at the sporting venue;
(d) providing one or more benefits to attendees located at the sporting venue; and
(e) providing one or more prizes to one or more attendees located at the sporting event;
wherein the first piece of information received from the input device indicates or confirms that the attendee is physically located within the sporting venue and the second piece of information is the attendees selection of the outcome of the sporting event located at the venue that the attendee is at or the attendees selection of the performance of one or more players that are participating in the sporting event located at the venue that the attendee is at; and
wherein the one or more prizes are provided to attendees who most correctly selected the outcome of the sporting event or the performance of the one or more players that are participating in the sporting event located at the sporting event venue.

2. The method of claim 1, wherein the method further includes receiving a third piece information from the input device of the one or more attendees located at the sporting venue.

3. The method of claim 1, wherein the input device is a mobile phone.

4. The method of claim 1, wherein the first piece of information received is a validation, password, code or image.

5. The method of claim 3, wherein the first piece of information received is login information.

6. The method of claim 2, wherein the third piece of information received is a request to purchase something during the sporting event.

7. The method of claim 1, wherein the one or more benefits provided are additional content about the sporting event or participants of the sporting event.

8. The method of claim 1, wherein the first piece of information received is the location of the user.

9. The method of claim 1, further requiring the one or more attendees to provide the second piece of information before the sporting event begins.

10. A method of providing one or more benefits to one or more attendees of a sporting venue; the method comprising:
(a) receiving a first piece of information from the input device of one or more attendees located at a sporting venue where a sporting event is taking or is about to take place;
(b) sending information about the sporting event at the sporting venue to the input device of the one or more attendees located at the sporting venue;
(c) receiving a second piece of information from the input device of the one or more attendees located at the sporting venue regarding the outcome of the sporting event or the performance of one or more players who participated in the sporting event;
(d) providing one or more prizes to one or more attendees located at the sporting event for correctly guessing the outcome of the sporting event or the performance of one or more players who participated in the sporting event.

11. The method of claim 10, wherein the method further includes, receiving a third piece information from the input device of the one or more attendees located at the sporting venue.

12. The method of claim 10, wherein the input device is a mobile phone.

13. The method of claim 10, wherein the first piece of information received is a validation, password, code or image.

14. The method of claim 10, wherein the first piece of information received is login information.

15. The method of claim 11, wherein the third piece of information received is a request to purchase something during the sporting event.

16. The method of claim 10, wherein the method further includes providing additional content about the sporting event or participants of the sporting event to the attendees of the sporting event.

17. The method of claim 10, wherein the first piece of information received is the location of the user.

18. The method of claim 10, further requiring the one or more attendees to provide the second piece of information before the sporting event begins.

19. A system for providing one or more benefits to one or more attendees of a sporting venue; the system comprising:
(a) a computer readable medium or one or more computers for receiving a first piece of information from the input device of one or more attendees indicating or confirming that the one or more attendees are located at the sporting venue where the sporting event is taking or is about to take place;
(b) a computer readable medium or one or more computers for sending information about the sporting event at the sporting venue to the input device of the one or more attendees located at the sporting venue;
(c) a computer readable medium or one or more computers for receiving a second piece of information from the input device of the one or more attendees located at the sporting venue regarding the outcome of the sporting event or the performance of one or more players who participated in the sporting event;
(d) a computer readable medium or one or more computers for determining the recipient of one or more prizes to one or more attendees located at the sporting event for correctly guessing the outcome of the sporting event or the performance of one or more players who participated in the sporting event.

20. The system of claim 19, further requiring the computer readable medium or one or more computers to receive the second piece of information before the sporting event begins.
